(19) United States
(12) Patent Application Publication
(10) Pub. No.: US 2007/0234564 A1
(43) Pub. Date: Oct. 11, 2007

(54) Method and apparatus for producing blades

(76) Inventor: Aaron Roni Shafir, Tel Aviv (IL)

Correspondence Address: EMPK & SHILOH, LLP, 116 JOHN ST,, SUITE 1201, NEW YORK, NY, 10038, US

(21) Appl. No.: 11/708,469

(22) Filed: Feb. 21, 2007

(30) Foreign Application Priority Data
Feb. 28, 2006 (IL) 174003

(51) Int. Cl. B23P 15/02

(52) U.S. Cl. 29/889.7

(57) ABSTRACT

A method and system for manufacturing blades, such as turbine blades, includes a device that measures the blade surface, a motorized edge cutter and a spacer, which regulates the extent of contact between the edge cutter and the blade.

### BACKGROUND

During manufacturing of blades, specifically turbine rotor blades or the like, a fine shaping of the blade edges is required. A “blade” or “blades” may also refer to other machined, shaped or otherwise produced parts, particularly those with at least one complex or compound surface.

The majority of the fine shaping of the blade edges, for example grinding or polishing, is accomplished by hand manufacturing—usually by holding a part against a tooling surface, such as a grinder or polisher. This yields a low quality product and produces non-repeatable blade(s) having inefficient performance. The inefficient performance of the blade(s) lead to inefficiency of a turbine or other final machine(s) incorporating or using the blade(s) which in turn affects the energy utilization of a device containing the turbine, or the like, for example a jet engine.

One common process for producing complete machined or otherwise finished parts of rigid or structurally stable materials (such as metals, alloys, ceramics, composites, polymers, plastics and the like), begins with pre-forming the materials into a rough or approximate shape (as by molding, stamping, casting, layering or the like), using known methods. The resulting shape is subsequently finished through grinding, polishing, sand-blasting, buffing, etching, lapping, ablation, laser, electro-treatment, chemical treatment, temperature treatment, analyzing or other known technique. The finished parts are then incorporated into larger assemblies.

More particularly, as an example, a jet engine turbine blade is commonly die-stamped in a press to create a complex surface shape from the rigid material—usually a metal, such as steel, or a composite. Commonly in a die-press the material (such as steel) is pressed at a sufficient pressure to plastically deform the material into its general finished shape. However, the die-press operation usually results in extra material, commonly called “flashing” extending from portions of the parts' surface(s), which must be removed by the above-noted finishing operations. A properly finished part should have a reproducible and identifiable finish over its surface(s), although that finish may be of different forms—such as an etched surface in some region(s), highly polished surface(s) in some regions(s) and particularly surface hardened or softened surface(s) in some region(s), as will be understood to one of skill in various arts.

Automatic equipment enables the production of high volume parts having simple, or non-complex, surfaces. More complex shaped parts, such as blades, still require changing or combining many processing heads which leads to one or more cumbersome process(es). (See, for example Robotic Finishing Applications, by Paul F. Miekstyn CMfgE, Sr. Product Manager, Robotic Systems, Acme Manufacturing, which is incorporated herein by reference).

Computerized numeric controlled (CNC) devices enable the operator to utilize (sometimes referred to as a “call”) different program(s) to control the CNC equipment to facilitate the production of a finished part, such as a blade or the like. Both the automatic equipment and CNC devices, however, are best suited for relatively simple shaped high volume parts and the production of more complex parts, such as blades, still involves, at least partially, hand manufacturing.

The development of robotic technology has enabled the automation of shaping applications for both simple and complex shape parts, such as turbine blades. Still there is a need to develop improved methods and apparatuses for efficient, reproducible blades.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

In an embodiment, there is provided a method for producing a blade, which may include adjusting a spacer functionally associated with an edge cutter based on a sampling of the blade.

Also provided is an apparatus for producing a blade, the apparatus may include a blade profiling device adapted to produce a sampling of the blade, a spacer functionally associated with an edge cutter and a controller adapted to adjust a position of said spacer based on the sampling of the blade.

Moreover, there is provided a blade having a complex surface along a substantial portion of its length, the blade may include a complex surface edge within a tolerance repeatability of less than 0.01 millimeters (hereinafter “mm”) along a substantial portion of the length of the complex surface.

In another embodiment there is provided a blade cutting apparatus, the apparatus may include a blade holder configured to retain a blade at spaced apart locations, a blade profiling device adapted to produce a sampling of the blade, an edge cutter configured to cut an edge of the blade and which may be motor-driven, a spacer configured to regulate contact between the blade and the edge cutter, and a controller adapted to adjust the position of the spacer based on the sampling of the blade.

Furthermore, in some embodiments, there is also provided a method for producing a blade which may include gripping the blade, providing an edge cutter configured to cut an edge of the blade and which may be a motor-driven, sampling a surface of the blade, providing a spacer configured to regulate contact between the blade and the edge cutter, providing a controller adapted to adjust the position of the spacer based on the sampling of the blade, and adjusting the spacer based on the sampling of the blade.

There is also provided a rotor which may include a set of blades having a complex surface along a portion of their respective lengths, wherein each of a subset of blades has a complex surface edge within a tolerance of less than 0.01 mm along a substantial portion of the length of the complex surface.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates a blade;

FIG. 2 schematically illustrates a cross section of a blade;

FIG. 3 schematically illustrates a partial cross section of a blade;

FIG. 4 schematically illustrates a partial cross section of a blade, similar to FIG. 3;

FIG. 5 schematically illustrates a partial cross section of a blade, similar to FIGS. 3 and 4;

FIG. 6A schematically illustrates a surface finishing apparatus/a blade cutting apparatus;

FIG. 6B schematically illustrates the apparatus of FIG. 6A configured for buffing operations;

FIG. 7 schematically illustrates a portion of the finishing apparatus/blade cutting apparatus of FIG. 6A;

FIG. 8 schematically illustrates a surface finishing apparatus/blade cutting apparatus; and

FIG. 9 schematically illustrates exemplary edge shapes.

FIG. 10 schematically illustrates a jet engine with a plurality of rotors.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

While a number of exemplary aspects and embodiments have been discussed above, those of skill in the art will recognize certain modifications, permutations, additions and sub-combinations thereof It is therefore intended that the following appended claims and claims hereafter introduced be interpreted to include all such modifications, permutations, additions and sub-combinations as are within their true spirit and scope.

As described above, the process of producing complete machined or otherwise finished parts (for example but not limited to, blades) of rigid or structurally stable materials, specifically metals (such as steel), but also ceramics, composites, plastics or any other materials known in the art or any future material, includes pre-forming the materials into a rough or approximate shape (for example, by molding, stamping, casting, layering or the like, under any known or future method or process). Pre-forming the materials is followed by subsequent process of finishing (for example, grinding, polishing, sand-blasting, buffing, etching, lapping, or by ablation, laser treatment, electro-treatment, chemical treatment, temperature treatment and the like) the parts—which may then be used or assembled into a more complex device or machine, such as the above mentioned turbines, or other machines as would be known to one of skill in such arts.

Commonly, in the pre-forming process, for example, a die-press or stamping, the produced part includes extra material, commonly called “flashing” extending from portions of the parts' surface(s), which must be removed by the above-noted finishing operations. The finishing processes are required to remove the extra material (flashing) according to predetermined geometric requirements and to produce properly finished parts. In work pieces, in general and in the blades manufacturing specifically, it is required that the finished products would have the same predetermined geometric structure, for example according to aerodynamic laws, and have a reproducible and identifiable finish over their surface(s), which may be complex and/or undulating.

There is thus provided according to some embodiments, a method for producing a blade, which may include adjusting a spacer functionally associated with an edge cutter based on a sampling of the blade.

The method may further include contacting an edge segment of the blade with the edge cutter, wherein the spacer regulates the contact between the blade and the edge cutter.

The method may further include modulating the spacer as the blade and the edge cutter are moved relative to one another in accordance with the sampling of the blade.

The method may further include buffing and/or polishing of the edge by any method known in the art, for example using one or more soft wheel(s), for example two soft wheels wherein one wheel rotates at the opposite direction from the other, wherein each wheel may polish one or more surface(s) of a blade and/or one or more edges.

According to some embodiments, there is provided an apparatus for producing a blade, which may include a blade profiling device which may be adapted to produce a sampling of the blade, a spacer functionally associated with an edge cutter and a controller adapted to adjust a position of the spacer based on the sampling of the blade. The controller may further be adapted to activate the edge cutter. The controller may further be adapted to cause contact between an edge segment of the blade and the edge cutter. When an edge segment of tile blade is contacted with an activated edge cutter a cutting process of the blade's edge may occur. The controller may be adapted to adjust the position of the spacer and thus to regulate the contact between the blade and the edge cutter which in turn regulates the extent of cutting of the blade's edge by the edge cutter. The controller may further be adapted to modulate the spacer as the blade and the edge cutter are moved relative to one another in accordance with the sampling of the blade.

The apparatus may further include one or more buffing and/or polishing means, such as soft wheel(s), which may be used to polish/buff the blade's surface and/or the blade's edge after cutting with the edge cutter. For example, the apparatus may include two soft wheels wherein one wheel rotates at the opposite direction from the other, wherein each wheel may polish one or more surface(s) of a blade.

The apparatus may further include a vibration damper functionally associated to a blade holder, wherein the vibration damper is adapted to ameliorate vibrational movements in one or more degrees of freedom. The blade holder may be functionally associated to a robotic arm. The robotic arm may be functionally associated to a robot.

According to some embodiments, there is provided a blade having a complex surface along a substantial portion of its length, the blade may include a complex surface edge within a tolerance repeatability of less than 0.01 mm along a substantial portion of the length of the complex surface.

In accordance with other embodiments there is provided a blade cutting apparatus which may include a blade holder configured to retain a blade at spaced apart locations, a blade profiling device adapted to produce a sampling of the blade, an edge cutter configured to cut an edge of the blade and which may be motor-driven, a spacer configured to regulate contact between the blade and the edge cutter, and a controller adapted to adjust the position of the spacer based on the sampling of the blade. The controller may be further adapted to cause contact between an edge segment of the blade and the edge cutter by adjusting the position of the spacer and thus regulating the contact between the blade and the edge cutter, which in turn regulates the extent of cutting of the blade's edge by the edge cutter, The controller may further be adapted to modulate the spacer as the blade and the edge cutter are moved relative to one another in accordance with the sampling of the blade. The spacer is adapted to be modulated by an actuator, which may be a servo motor actuator.

The blade cutting apparatus may further include a vibration damper functionally associated to a blade holder, wherein the vibration damper is adapted to ameliorate vibrational movements in one or more degrees of freedom. The blade holder may be functionally associated to a robotic arm. The robotic arm may be functionally associated to a robot.

According to other embodiments there is provided a method for producing a blade which may include gripping the blade, providing an edge cutter configured to cut an edge of the blade and which may be a motor-driven, sampling a surface of the blade, providing a spacer configured to regulate contact between the blade and the edge cutter, providing a controller adapted to adjust the position of the spacer based on the sampling of the blade, and adjusting the spacer based on the sampling of the blade. The method may further provide for sampling of the blade wherein the geometry of the blade is determined. The method may include contacting an edge segment of the blade with the edge cutter, wherein the spacer regulates the contact between the blade and the edge cutter. Furthermore, the method may include modulating the spacer as the blade and the edge cutter are moved relative to one another in accordance with the sampling of the blade.

According to some embodiments there is provided a method for producing a blade, which may include buffing the edge.

There is further provided a rotor, which may include a set of blades having a complex surface along a portion of their respective lengths, wherein each of a subset of blades has a predefined complex surface edge within a tolerance of less than 0.01 mm along a substantial portion of the length of the complex surface.

The tolerance repeatability may be less than 0.005 mm. The tolerance repeatability may be less than 0.004 mm. The tolerance repeatability may be less than 0.003 mm. The tolerance repeatability may be between 0.001-0.003 mm. The tolerance repeatability may be about 0.002 mm. The tolerance repeatability may be less than 0.002 mm.

“Tolerance” may include the measurement of an error of interest, such as repeatability and/or reproducibility. Tolerance may also include the permissible deviation from a specified value of a structural dimension. Tolerance may also be expressed as a percent.

A “complex” surface may include any surface that is not entirely planar along its length and breadth; such surfaces may include arcuate, non-symmetrical, bent, curved, irregular, undulating, patterned, and other surface configurations.

A “compound” surface may have more than one surface type, such as a planar portion and a complex portion or at least two different complex portions.

A “substantial portion” of the length of the complex surface may be at least 10%. The substantial portion of the length of the complex surface may be at least 15%. The substantial portion of the length of the complex surface may be at least 25%. The substantial portion of the length of the complex surface may be at least 50%.

“Producing” may include manufacturing or any step/stage or combination of steps/stages in the manufacturing process, for example, cutting, forming, pre-forming, shaping and finishing.

“Finishing” or “finishing process(es)” as referred to herein may include any process that involves material (such as metal but also includes composites, ceramics, alloys and the like) removal. More specifically, “finishing” or “finishing process(es)” may relate to the removal of excess material, for example from weld beads, flash on forgings or stamped metals, or run-outs on castings. “Finishing” or “finishing process(es)” may include grinding, polishing, buffing, tumbling, etching, glass bead blasting, electro-polishing, matching mill finishes, sand-blasting, lapping, ablation, laser-treatment, chemical treatment, temperature treatment, annealing or the like or any other method known in the art.

“Grinding” as referred to herein may include any process that uses friction with a rough surface to remove, wear away or smooth a surface of a work piece or a part. Grinding may also include the action of crashing or breaking up material into small particles or reducing a material into a powder. Grinding may include hand grinding or may utilize grinding wheels, progressive grinding (for example, employing a series of wheels of decreasing grit size in order to smooth a surface), belt grinding (as a closed loop of coated abrasives of various grit sizes, also called) and/or other grinding devices and/or methods.

“Grinding wheel(s)” as referred to herein may include expendable wheels that may carry an abrasive material on its periphery. Grinding wheels usually include coarse particles pressed and bonded together to form an abrasive solid. Circular shape, various profiles and cross sections are available depending on the intended usage for the wheel. Grinding wheel may be made for example, from a solid metal composition such as steel or aluminum having particles bonded to its surface.

The particles used to compose the abrasive material used for grinding may include for example silicon carbide (SiC), aluminum oxide (Al₂O₃), emery (Al₂O₃—Fe₃O₄), zirconium oxide, cubic boron nitride (CBN—boron nitride with a cubic crystalline structure which with diamond may comprise the class of abrasives also known as superabrasives) diamond particles, any combination thereof or the like.

“Polishing” as referred to herein may include any process of smoothening a surface by using rubbing or a chemical action.

“Buffing” as referred to herein may include a process generally composed of cutting down material. An example of cutting down buffing may include applying an abrasive intermittently to a buffing wheel by rubbing a cutting compound in bar or stick form against it as it rotates. Buffing may further include coloring the surface of the material.

“Etching” as referred to herein may include dry or wet methods, used for inducing changes on a surface of a material. Dry etching may include, for example, glass-bead and sand blasting. Wet etching may employ, for example, chemical solutions (may also referred to as a “chemical treatment”), which, for example may include one or more acids. Etching may also include optical etching, which may include changes on a surface of a material using illumination techniques such as laser illumination.

“Lapping” as referred to herein may include applying a slurry containing an abrasive compound to a lap (tool), placing a work part on top of the lap and moving it to cause cutting and/or material removal at a controlled rate.

“Electro-treatment”, also be referred to as “Electra-polishing”, may include a process for changing a surface of a material, specifically, removing a layer from a surface of a material, which is accomplished by applying an electrical current to the material and inducing a chemical or physical reaction which, in turn, induces a change in the surface of the material.

“Temperature treatment” may include a process for changing a surface of a material by changing the surface's temperature, for example heating.

“Tumbling” as referred to herein may generally include a process combined rubbing and abrasive action.

Additional details regarding finishing process(es), method(s) and apparatus(es) are known to those skilled in the art of manufacturing turbine blades.

An “edge” as referred to herein may include a place where two surfaces meet. For example, an edge of a blade may be a place where a first surface (such as a top aerofoil plane) and a second surface (such as a bottom aerofoil plane) of the blade meet. Examples of blade edges are a leading edge (LE) and a trailing edge (TE). An edge as referred to herein may include an LE, a TE or both.

A “complex surface edge” as referred to herein may include an “edge” of a blade in which a first surface and/or a second surface may be “complex surfaces”.

An “edge segment” may include a portion of the edge. For example, an edge segment may include 0.1-10% of the length of the blade, 1-5% of the length of the blade, 3-7% of the length of the blade, 5-15% of the length of the blade, 10-30% of the length of the blade, 20-50% of the length of the blade, 30-70% of the length of the blade, 1-100% of the length of the blade or any other portion of the blades edge.

A “leading edge” (LE) may include the foremost edge of a moving structure, such as an airfoil. LE may include a line connecting the forward-most points of a blades profile. LE may be the front edge of the blade. When a blade is moving forward, the LE may be that part of the blade that first contacts the air.

A “trailing edge” (TE) may include the rearmost edge of a moving structure, such as an airfoil. TE may include a line connecting the rear-most points of a blades profile. TE may be the rear edge of the blade.

Under some circumstances, for example when the direction of the movement of the structure (such as the blade) is changed, from an aerodynamic point-of-view, the TE may become the LE and the LE may become the TE.

An “edge cutter” as referred to herein may include an element adapted shape and/or form and edge, for example an edge of a blade.

A “spacer” as referred to herein may include an element adapted to regulate the extent of cutting of the blade's edge by the edge cutter by regulating the contact between the blade and the edge cutter. The spacer may be used to determine the extent/amount of cutting of the blade's edge by the edge cutter according to predetermined requirements. The physical location of the spacer relative to the edge cutter may determine the blade cutting by the edge cutter. For example, the edge cutter may be allowed to be in contact with the blades edge and thus to cut/grind the blades edge until it is hindered by the physical location of the spacer.

The spacer may be modulated by an actuator. The actuator may be for example a servo motor actuator. The term “actuator” may be used interchangeably with “locator”.

“Regulate” or “regulating” as referred to herein may include adjusting to a certain level, controlling or a combination thereof.

“Modulating the spacer” as referred to herein may include adjusting, adapting and/or changing the location of tile spacer, for example, as the blade and the edge cutter are moved relative to one another (for example in accordance with the sampling of the blade).

“Normal” as referred to herein may include substantially vertical, perpendicular at right angles or at a 90 degree angle

“Normal to the edge” as referred to herein may include substantially vertical, perpendicular at right angles or at a 90 degree angle.

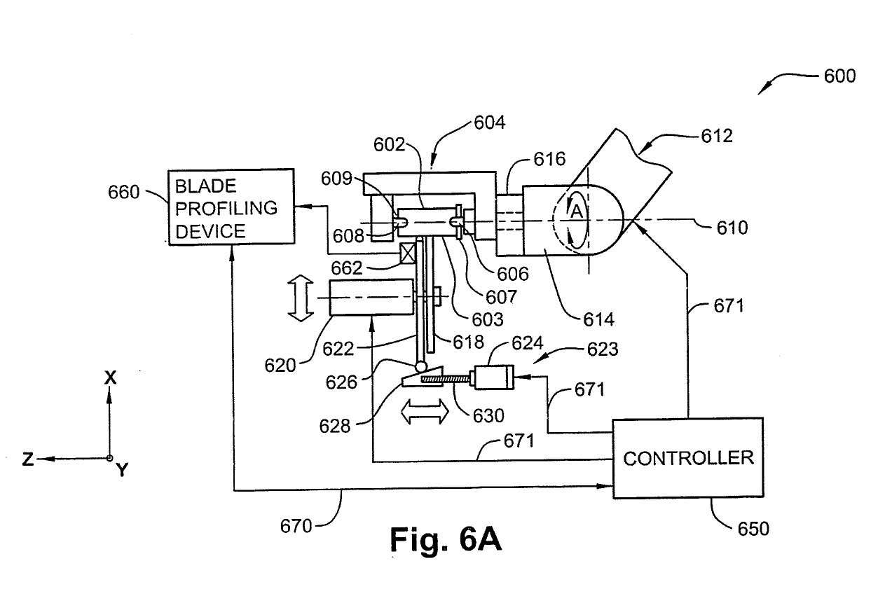

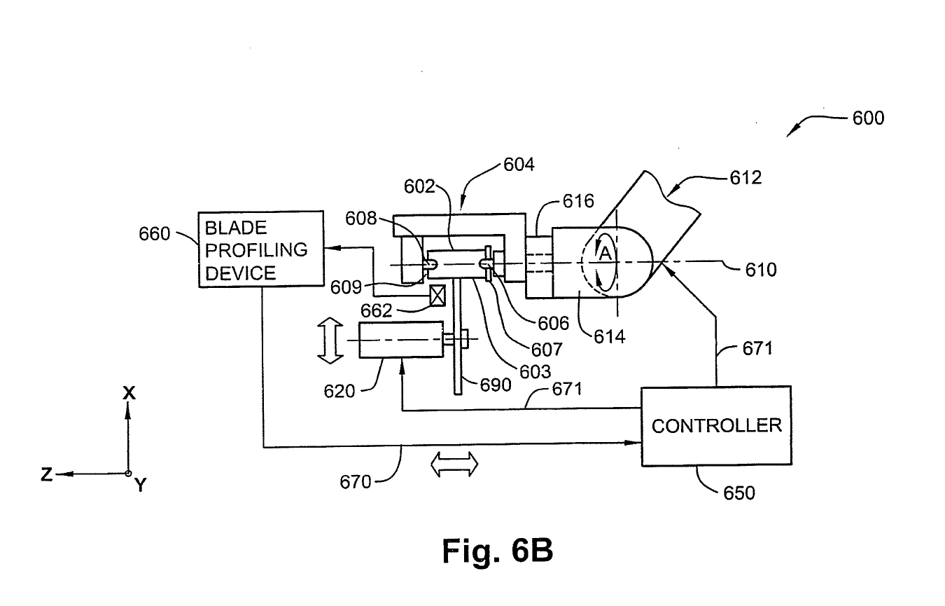

The spacer may be modulated as the blade and the edge cutter are moved relative to one another in accordance with varying geometric requirements at each point or segment of the blade's edge. For example, if at point or segment (A) along the blade's edge more material should be cut and/or removed (according to predetermined geometrical requirement) than in point or segment (B) along the blade's edge, the spacer is adapted to change its location to allow the desired amount of material at point or segment (A) to be cut and/or removed, as the blade and the edge cutter are moved relative to one another (see for example FIG. 6A, which will be fully described hereinafter).

Blades are normally required to have at least partially complex and/or undulating surfaces. In other words, each point or segment on the surface of a blade may have a different structure than other point or segment on the surface of the same blade. Moreover, contrary to the requirement that all blades produced by the same process have identical shapes and structures, each of the blades pre-formed into a rough or approximate shape, for example by stamping, have a slightly different shape and structure. The undesired excess material that is left after pre-forming of the blades may also vary from one point or segment to another on the surface of a single blade. The requirements from the finishing process may vary from one point or segment to another on the surface of a single blade and from one blade to another. It is therefore an aspect of this disclosure to determine the geometry and shape of a blade prior to finishing its surface. The determination of the blade's geometry or the three-dimensional profiling of the blade may be accomplished by any method known in the art such as contact or non-contact techniques. An example of a non-contact technique is an optical profiling such as laser profiling.

A “profiling device” may include a device adapted to provide data related to the blade parameters such as, for example, structure, shape, configuration, geometry and/or surface shape. A profiling device may be adapted to provide sampling of a blade by measuring one or more parameters at one or more points and/or scanning at least part of a surface of a blade by any method known to a person of skill in the art, such as optical methods. Profiling devices using optical methods are well known in the art and may include, for example, the use of laser.

“Profiling” may include obtaining data related to the blade's structure, shape, configuration, geometry and/or surface shape. Profiling may include sampling of a blade

“Sampling” of a blade may include measuring one or more parameters at one or more points and/or scanning at least a part of the surface of a blade by any method known to a person of skill in the art and may include the use of a profiling device.

A “vibration damper” as referred to herein may include a device or a means that is adapted to reduce the amplitude of vibrations or oscillations. Examples of such devices or means may be, a float damper, a shock absorber, a tuned mass damper or any other damper known in the art.

A “blade holder” (may also be interchangeably called a “gripper” or a “blade gripper”) as referred to herein may include any device, means or element that is adapted to grasp, grip or hold a blade. The blade holder may be adapted to allow twisting the blade around one or more axis/axes. The blade holder may be adapted to hold the blade in one or more gripping points (reference points).

A “rotor” as referred to herein may include a part adapted to rotate. A rotor may be a rotating part of a machine such as a turbine, motor, helicopter, alternator, generator and the like.

A “turbine” as referred to herein may include any of various machines, such as a rotary engine, in which the kinetic energy of a moving fluid or gas is converted to mechanical power.

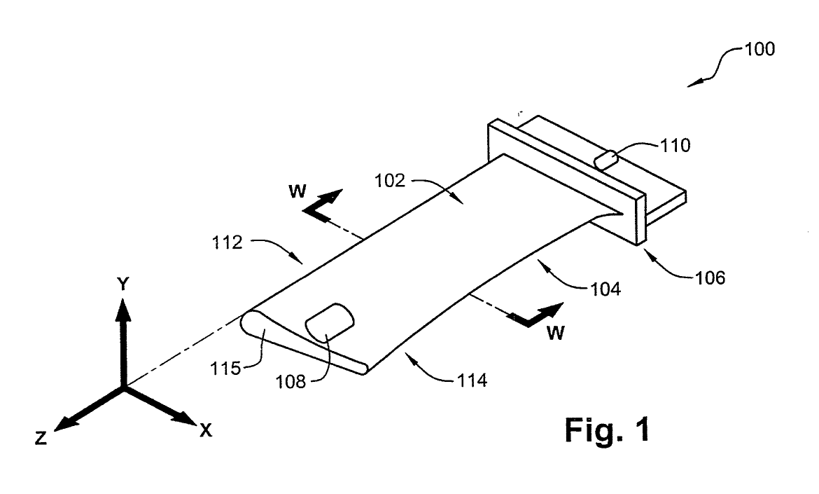

An example of a final shape of a complex surfaced part is shown in FIG. 1 which is directed to an example blade (100). The blade (100) includes a first surface (102) (such as a top surface) on one side of the blade, a second surface (104) (such as a bottom surface, obscured but referenced) on the other side of the blade (100), a blade (100) root (106) that is adapted to connect to a base (not shown), which for example may be a turbine ring or rotor, or the like and a blade end (115) usually at the opposite end of the blade (100) root (106) of the blade (100). For ease of understanding, an X-Y-Z coordinate axis is shown for FIG. 1. The blade (100) may further include one or more, but shown as two, reference points, which may be referred to as “pips”. A pip, if more than one, is preferably located at a substantial separation from another pip to assist in alignment and securing the blade (100) into or on a base (not shown). Preferably, pips for the blade (100) are located as front (108) pip and rear (110) pip on different sections or parts of the blade (100). As shown, pip (108) is formed on the (top) first surface (102) of the blade (100) near the end (115) and substantially distanced along the blade (100) length (shown in the Z direction) from a second, rear (110) pip, which is formed on the top surface of the root (106) of the blade (100). In addition, the blade (100) includes a leading edge (LE) (112) shown at a front edge and a trailing edge (TE) (114) shown at a back edge.

There may be additional pips (not shown), such as on the second surface (104) of the blade (100) usually opposite the front (108) pip and/or opposite the rear (110) pip on the blade (100). The use of multiple pips permits better referencing and/or securing of the blade (100) into a base, and to a gripper, which is described hereinafter.

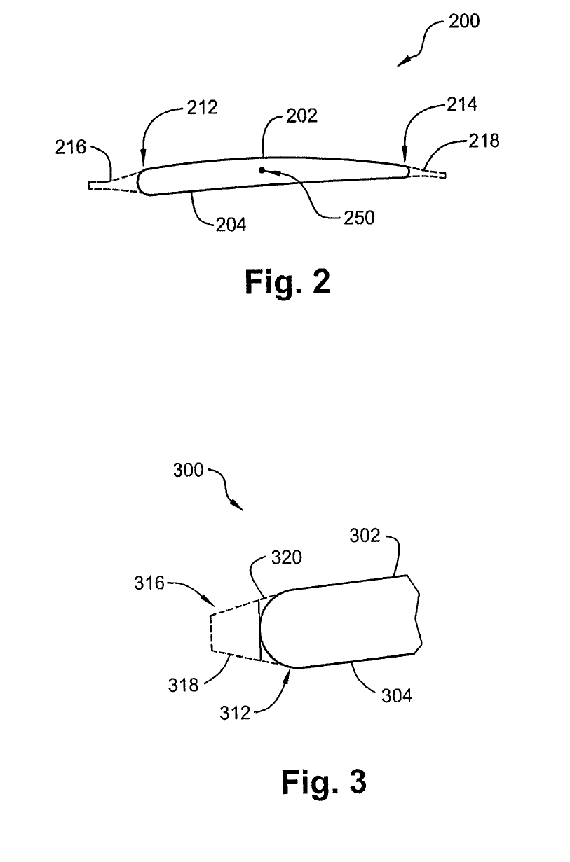

Either or both of the first surface (102) and/or the second surface (104) may have a complex or undulating shape, which may be leaf-like or potato-chip like. A principal consideration is repeatability of the shape from blade to blade. For example, potato chips are more easily stacked for packaging if all of their shapes match within a set tolerance—such as PRINGLES™ chips which can come in a tube-shaped can—as opposed to more traditional potato chips which have irregularly shaped surfaces. The overall shape of the blade (100) may have a constant or tapering thickness as shown in FIG. 2 which is cross section of blade (100) taken along the line (w-w) of FIG. 1. In this example, the blade (100) shows a tapering pattern from the LE (112) through to the TE (114) having essentially a constant thickness along the length of the blade (substantially in the Z direction), which extends from the end (115) to near the blade root (106) at any point along its length. Further, it is expected and commonly practiced that such blades may have a twisted or undulating overall surface shape(s) or varying thicknesses as would be known to one of skill in the art of blades, such as turbine blades, rotor blades and the like.

FIG. 2 schematically illustrates a cross section of the blade (100) of FIG. 1 along the line (w-w) showing a blade (200), and having a first surface (for example, an airfoil plane) (202) on one (top) side of the blade (200), a second surface (for example, an airfoil plane) (204) on the other (bottom) side of the blade (200), a leading edge (LE) (212) (on a front edge) and a trailing edge (TE) (214) (on a rear edge). The blade (200) has a center (250) such as a center of mass, center of arc, center of rotation or centroid, as will be understood by one of skill in the art. Also shown in FIG. 2 is an example of excess material or flash (216) and flash (218) that is shown as being present and is usually associated with an obscuring of the leading edge (212) and/or trailing edge (214) of the blade (200) (respectively) and which is usually resulting from the manufacturing of the blade, for example during the process of forging and/or stamping, or the like. The excess of material, herein called flash (216) and (218), may be removed from the blade (200) by cutting, milling, grinding or by any other appropriate method known in the art, and as previously described, to form or fashion the appropriate LE (212) and TE (214). The particular method(s) apparatuses) and system(s) to remove the flash (216) and (218) are further described below, as is the preferred final blade device(s) after the flash (216) and (218) have been removed.

FIG. 3 schematically illustrates a partial cross section of a blade (300), which is of the type as shown as the front portion of the blade (200) of FIG. 2 or a portion near the leading edge (LE) (112) of a cross-section of the blade (100) as taken along a line, such as w-w, of FIG. 1) including a portion of a first surface (302) on one (top) surface of the blade (300), a second surface (304) on the other (bottom) surface of the blade (300) and a leading edge (LE) (312). Excess of material or flash (316) that is present on the leading parts of the blade (300) as from the manufacturing of the blade (300), for example during the process of forging, stamping or the like, is shown near, and attached to the desired LE (312). The flash 316 may have multiple sub-flash (318, 320) portions, which may be removed or shaped differently, and/or by different processes or methods. The excess material or flash (316) may be removed from the blade (300) as by cutting, milling, grinding or by any other appropriate method known in the art, and as described herein, to form or sub-fashion an appropriate LE (312). After removing a first portion of excess material such as flash (318) the remaining excess material or sub-flash (320) may be left obscuring the preformed or appropriate LE (312) shape, and may be removed from the blade by the same or another method in order to form and finish an appropriate LE (312), which complies with predefined geometric requirements of the blade (300).

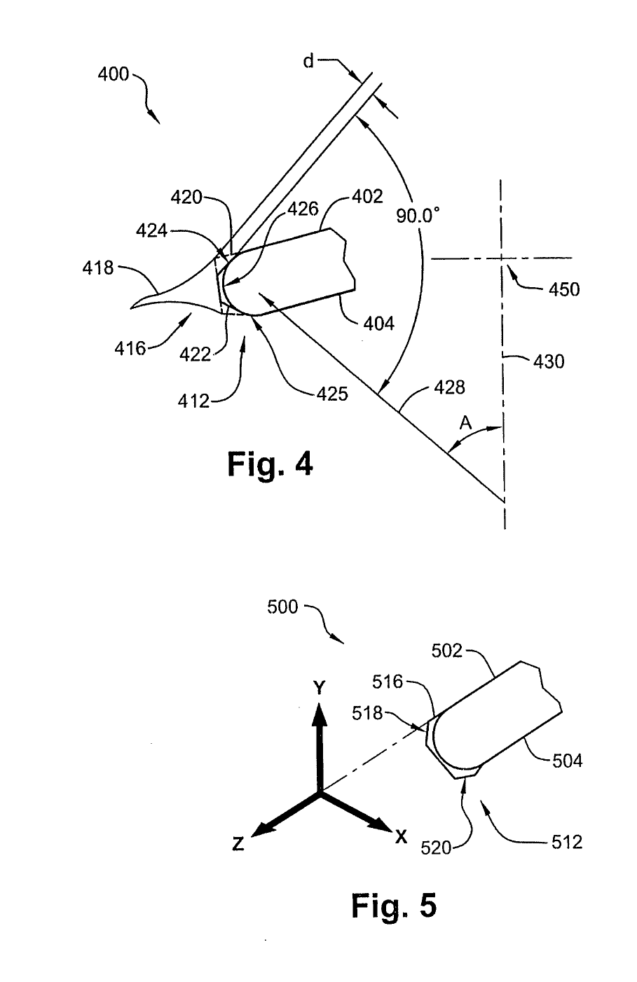

FIG. 4 schematically illustrates a partial cross section of a blade (400) as along the line (w-w) of a blade (100) of FIG. 1, which may be of the type shown in FIG. 2 at (200), and/or FIG. 3 at (300). The blade (400) includes a first surface (402) on one (top) side of the blade (400), a second surface (404) on the other (bottom) side of the blade (400) and a leading edge (LE) (412) which is shown partially obscured by excess material (herein referred to as “flash”) as further described.

FIG. 4 shows an example of excess material or flash (416) that is present as associated with and obscuring the leading edge (412) of the blade (400) as from the manufacturing of the blade (400), for example during the process of forging and/or stamping and the like. The excess material or flash (416) may be removed from the blade (400) by cutting, milling, grinding or by any other appropriate method known in the art and/or as described herein to form or fashion an appropriate LE (412). The flash (416) may have multiple sub-flash (418, 420, 422) portions, which may be removed or shaped differently, and/or by different processing methods. After removing the excess material or sub-flash (418, 420), the excess material or sub-flash (422) may still be left obscuring the preferred or appropriate LE (412) shape, and may be removed from the blade by the same or another method in order to form an appropriately shaped leading edge (412) to match predefined geometric requirements of the blade (400).

As an example forming operation to obtain a preferred or appropriate LE (412) shape from a flash (416) or sub-flash (418, 420, 422) obscured LE (412) shape (as similarly shown in FIG. 2 for LE (212) obscured by flash (216)) a first sub-flash (418) portion is removed. The operation or method chosen to remove the sub-flash (418) portion may need not be directed to or chosen for its effect upon the surface finish of the remaining material, as the remaining material is also expendable and/or undesirable sub-flash (420). The operation or method chosen to remove the sub-flash (420) which contacts a portion of a preferred or appropriate LE (412) location should be directed to or chosen from whatever various material removing operations that would permit preferred surface shaping and/or surface patterning at or near; such portion of the LE(412). Alternatively, a first removal operation for sub-flash (418) may not be performed, prior to the removal operation for sub-flash (420) (as sub-flash (418) would be removed when sub-flash (420) is removed).

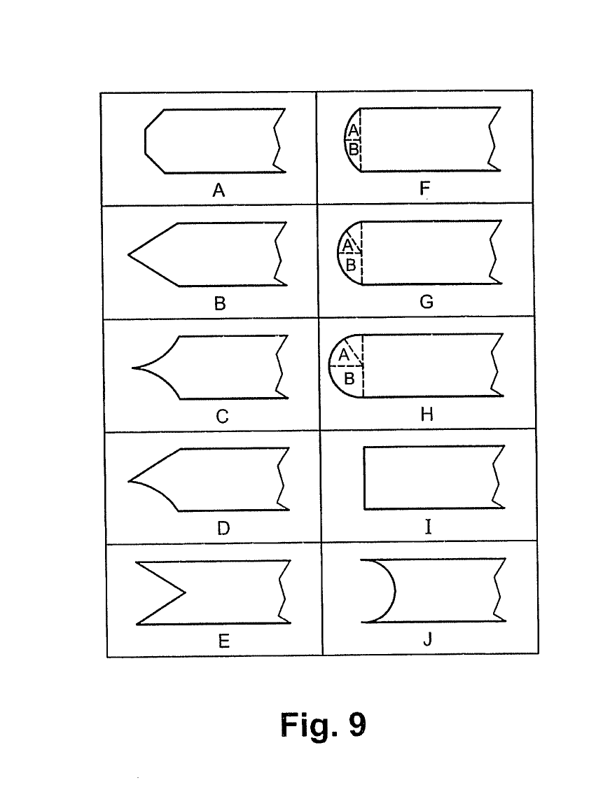

A method and operation of removal of sub-flash (420) may be used to pattern a portion of a preferred or appropriate LE (412) as at arc (424). Arc (424) may be chosen as an angle or curve connecting the first surface (402) near the LE (412) with the central arc (426) of the LE (412). The central arc may be a sharp edge, wedge, complex shape, smooth and symmetric spherical or smooth aspherical arc (as shown in FIGS. 2, 3, 4 and 5) or other shapes as shown and described with reference to FIG. 9. Similarly, such shapes, or others, may be used for trailing edge (TB) portions, as would be found at TE (114) of FIG. 1 or TE (214) of FIG. 2.

After sub-flash (420) has been removed from obscuring the arc (424) near the first surface (402) and arc (425) near the second surface (404), as by any pre-selected excess material removal operation (such as cutting or grinding) the central arc (426) of LE (412) is still obscured by sub-flash (422). An excess material removal operation (such as lapping or polishing) may be used to remove the remaining sub-flash (422) to expose and fashion an appropriate LE (412). One method of polishing may be, for example, using a soft polishing wheel spinning in a first direction on one side (such as near the first surface (402) and top part of the LE (412) and a soft polishing wheel spinning in an opposite direction for the other bottom part of the LE (412) nearer the second surface (404)). Thus, the polishing operation may form smooth surface from the first surface (402) across arc (424) and center arc (426) and arc (425) to the second surface (424). By changing the speed and/or the roughness of a polishing wheel, various symmetric or asymmetric LE (412) shapes may be produced, as described in relation to FIG. 9.

As an example of one preferred LE (412) shape, such as a spherical arc (as more fully described at FIG. 9) the center (450) of blade (400), similar to the center (250) of blade (200) of FIG. 2, may be used as a reference for the radius of arc of the central arc (426) and the arcs (424, 425). For such a symmetric, smooth, spherical arced LE (412) an angle A is shown formed between ray (428) and ray (430) at approximately 90° (“normal”) to the first cut surface which forms at least a portion of arc (424), as by a tangent to that arc (424). The removal of the sub-flash (420) in the vicinity of arc (424) may be accomplished by a cutting or grinding wheel (not shown) having a thickness dimension shown by “d”, so long as the cutting, grinding or other removal of sub-flash (420) near arc (424) is accomplished to provide a tangent which is normal to tile ray at an angle A in relation to the center (450) of the blade (400). A similar removal operation would remove the sub-flash (420) obscuring the arc (425) prior to polishing away the remaining sub-flash (422) obscuring the central arc (426).

FIG. 5 schematically illustrates a partial cross section of a blade (500), including a first (top) surface (502) on one side of the blade (500), a second (bottom) surface (504) on the other side of the blade (500) and a leading edge LE (512). LE (512) is shown obscured by excess material or flash (516) which may be formed or left after the formation of the blade (500) as previously described. The flash (516) is shown with different configurations, such as at location (518) where the upper (top) area of the flash (516) is in the same directional line (Z direction) as the first (top) surface (502). Alternatively, the flash (516) at location (520) is shown extending below (beyond) the same directional line (Z direction) as the second (bottom) surface (504). The remaining flash (516) continues to obscure the leading edge (512) in a manner similar to that shown in FIGS. 1-4. The same, or another, method as described regarding the previous figures may be used to produce an appropriate LE (512).

FIG. 6A schematically illustrates an apparatus for producing a blade (600) also referred to as a surface finishing apparatus, which may also be a blade cutting apparatus. A blade (602) (which may be similar to blade (100) and (200) as shown in FIGS. 1 and 2) having a blade edge (603) is mounted on a blade holding device or gripper (604) that holds the blade (602) by one or more, but shown as two, gripping elements (which may be adapted to hold the two reference points, not shown, as those described in FIG. 1 at (108) and (110)). A first gripping element (606), which is adapted to hold the blade (602) as by securing or holding a reference point (not shown) which may be located in proximity to the root (607) of the blade (602), and a second griping element (608) which is adapted to hold the blade (602) located in proximity to the end (609) of the blade (602). The blade (602) may be rotated about an axis of rotation, such as axis (610) (which may be referred to as “axis six” to one of skill in the art) of a robotic controlled device or robot (612) shown with a direction of primary revolution at “A”. The gripper (604) is functionally connected to a robotic arm (614) by a floating element or vibration damper (616). The surface finishing of a blade edge (603), such as an LE or TE, may be performed as by using a grinder or an edge cutter (618), which may be for example, a cutting/grinding wheel (which may be coated with CBN as noted previously), and may be operated by a motor (620), for example, a spindle motor. The edge cutter (618) may be functionally associated with a spacer (622). The spacer (622) may be controlled by and accurately positioned in relation to the edge (603) of the blade (602), as by locator (623). The locator (623) may include a motivator (624), which may be, for example, a servomotor. The motivator (624) is operably connected to an inclined plane (628) by a screw (630). The spacer (622) has at one end a roller (626), which may rest on the inclined plane (628). The opposite end of the spacer (622) from the roller (626) is adapted to contact a portion of the blade (602) as will be discussed hereinafter. The spacer (622) may be operated by the motivator (624) by means of roller (626), which may roll on inclined plane (628). The motivator (624) may turn the screw (630) that may move the inclined plane (628) along an axis and thus change the location of the spacer (622) along the x axis (up and/or down). The change in the location of the spacer (622) along the x axis may in turn, determine the extent of the position of the other end of the spacer (622) near or in contact with the blade (602) which will determine the amount and position of flash material to be removed from the blade (602) by the edge cutter (618), as described hereinafter.

A blade profiling device (660) including a sampler (662) is used to sample blade (602) parameters so as to determine the amount and position of flash material to be removed from blade (602). The blade (602) parameters are input to controller (650) which in response to the inputs (670) sends control signals (671) to the locator (623), the motor (620), and the robot (612) devices. The control signals (671) may include signaling related to operation and positioning of these and other interconnected devices such as, for example, accurate positioning of the spacer (622) by the operation of the motivator (624) in the locator (603), the rotation of the blade (602) around axis six (610) by the operation of the robot (612), and the high-speed revolving of the edge cutter (618) by the operation of the motor (620).

In another embodiment of the present disclosure FIG. 6B schematically illustrates the surface finishing apparatus (600) of FIG. 6A in a configuration adapted for performing buffing operations. Edge cutter (618) in FIG. 6A is replaced by a buffing wheel (690). Optionally removed from surface finish apparatus (600) of FIG. 6A are the locator (623), including the motivator (624), the screw (630) and the inclined plane (628), and the spacer (622), although other embodiments of the present disclosure may include these components. Furthermore, additional embodiments may include a plurality of buffing wheels (690).

The blade (602) is mounted on the gripper (604) that holds the blade (602) by one or more, but shown as two, gripping elements. The first gripping element (606), which is adapted to hold the blade (602) as by securing or holding the reference point (not shown) which may be located in proximity to the root (607) of the blade (602), and the second griping element (608) which is adapted to hold the blade (602) located in proximity to the end (609) of the blade (602). The blade (602) may be rotated about the axis of rotation (610) of the robot (612) shown with the direction of primary revolution at “A”. The gripper (604) is functionally connected to the robotic arm (614) by the floating element or vibration damper (616). Buffing of the blade edge (603), such as the LE or TE, may be performed by using the buffing wheel (690), which may be operated by the motor (620), for example, the spindle motor.

The blade profiling device (660) including the sampler (662) is used to sample blade (602) parameters as may be related to the buffing operation. The blade (602) parameters are input to the controller (650) which in response to the inputs (670) sends control signals (671) to the motor (620) and the robot (612) devices. Control signals (671) issued by the controller (650) may include, for example, signaling related to operation and positioning of these and other interconnected devices such as, for example, the rotation of the blade (602) around axis six (610) by the operation of the robot (612), and the high-speed revolving of the buffing wheel (690) by the operation of the motor (620).

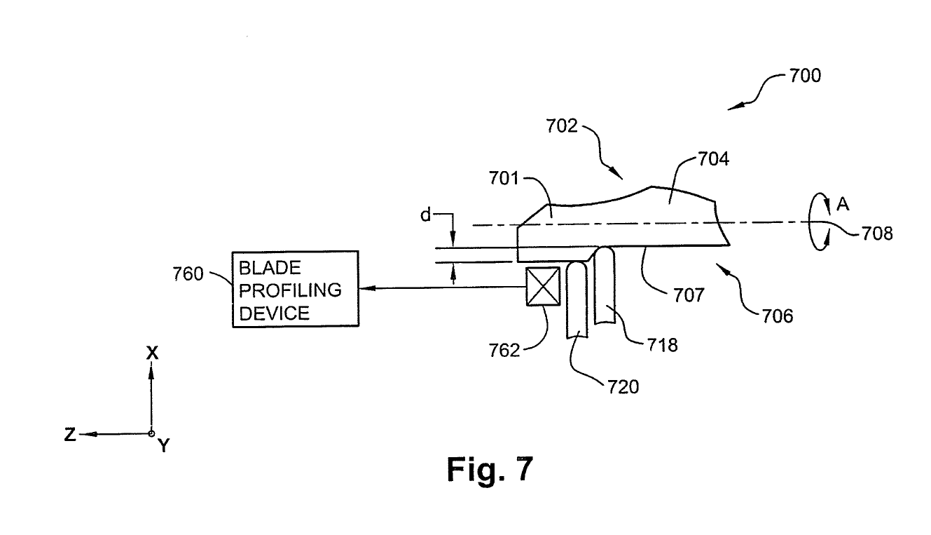

FIG. 7 schematically illustrates a portion (700) of the finishing apparatus and/or the blade cutting apparatus of FIG. 6A. Blade (702) includes a first surface (701) on one (top) side of the blade, a second surface (706) on the other (bottom) side of the blade and a blade edge (707), which may be LE or TE. The blade (702) may be rotated about an axis of rotation, such as axis (708), shown with a direction of revolution “A”. The surface finishing of a blade edge (707), such as an LE or TE, may be performed as by using a grinder or an edge cutter (718), which may be for example, a cutting/grinding wheel (which may be coated with CBN as noted previously), and may be operated by a motor (not shown). A blade profiling device (760) including a sampler (762) is adapted to sample blade (702) parameters, the sampling information serving as an input to a controller (not shown). The blade profiling device (760) including the sampler (762), and the controller may be similar to or the same to those shown in FIG. 6A at (660), (662), and (650). The edge cutter (718) may be functionally associated with a spacer (720). The spacer (720) may be controlled by and accurately positioned in relation to the edge (707) of the blade (702), as by a locator (not shown). One end of the spacer (720) is adapted to contact a portion of the blade (702). The spacer (720) may be operated by the motivator (not shown) that may change the location of the spacer (720) along the x axis (up and/or down). The change in the location of the spacer (720) along the x axis may in turn, determine the extent of the position of the end of the spacer (720) near or in contact with the blade (702) which will determine the distance shown by “d” of the cutting of the edge (707) of the blade (702) by the edge cutter (718) and thus the amount and depth of flash material to be removed from the blade (702) by the edge cutter (718), as described hereinafter.

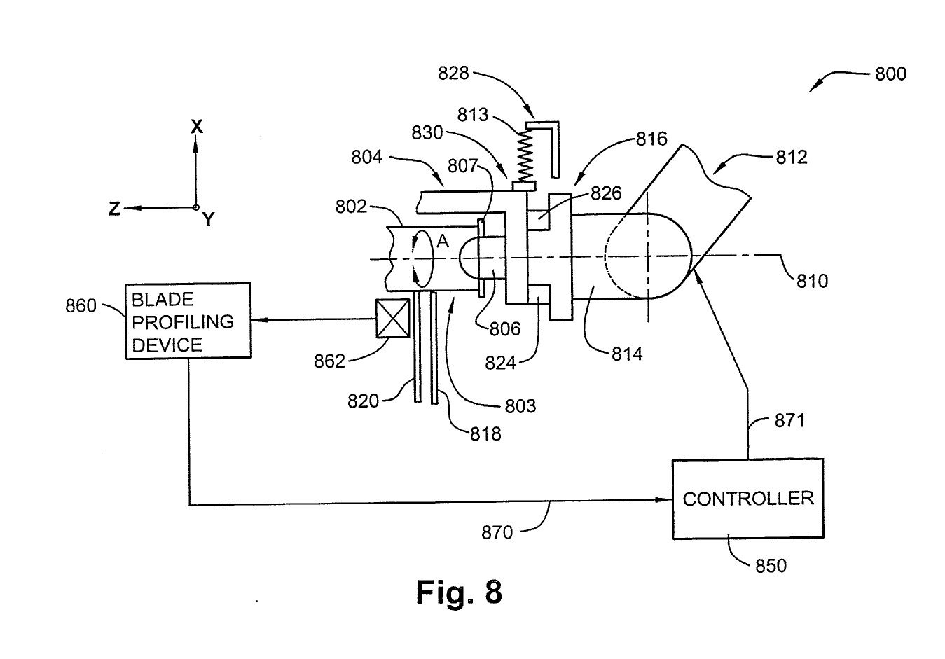

FIG. 8 schematically illustrates a surface finishing apparatus (800) and/or a blade cutting apparatus similar to the apparatus (600) of FIG. 6A. A blade (802) (which may be similar to blade (100) and (200) as shown in FIGS. 1 and 2) having an edge (803) is mounted on a blade holding device or gripper (804) that holds the blade (802) by one or more, but shown as one, griping elements (which may be adapted to hold the two reference points, not shown, as those described in FIG. 1 at (108) and (110)). The gripping element (806) is adapted to hold the blade (802) as by securing or holding a reference point (not shown), which may be located in proximity to the root (807) of the blade (802). The blade (802) may be rotated about an axis of rotation, such as axis (810) (which may be referred to as “axis six” to one of skill in the art) of a robotic controlled device or robot (812) shown with a direction of primary revolution at “A”. The gripper (804) is functionally connected to a robotic arm (814) by a floating element or vibration damper (816). The surface finishing of a blade edge (803), such as an LE or TE, may be performed as by using a grinder or an edge cutter (818), which may be for example, a cutting/grinding wheel (which may be coated with CBN as noted previously), and may be operated by a motor (not shown). The edge cutter (818) may be functionally associated with a spacer (820). The spacer (820) may be controlled by and accurately positioned in relation to the edge (803) of the blade (802), as by a locator (not shown). One end of the spacer (820) is adapted to contact a portion of the blade (802). The spacer (820) may be operated by a motivator (not shown) that may change the location of the spacer (820) along the x axis (up and/or down). The change in the location of the spacer (820) along the x axis may in turn, determine the extent of the position of the end of the spacer (820) near or in contact with the blade (802) which will determine the amount and depth of flash material to be removed from the blade (802) by the edge cutter (818). The gripper (804) is adapted to move along the x axis (up and/or down) against the spring (813). The spring (813) may be any item or device, which can apply force along the x axis to counteract or ensure positive contract between the spacer (820) and the edge (803) of the blade (802). Spring (813) may be, for example, air pressure cylinder, shock absorber, coil, leaf or helical or other spring of the sort known to those skilled in the art. The spring (813) is connected to a support (828), which permits compressive force of the spring (813) to be transmitted to the gripper (804) as through a base (830) mounted on or attached to the gripper (804). This arrangement provides an additional benefit of potential vibration dampening in the X direction, especially when spacer (820) is contacting the blade (802).

The gripper (804) may be connected by a floating element or a vibration damper (816) to a robotic arm (814), which may be connected to a robot (812). During the finishing process, the pressure applied between the blade (802) on the spacer (820) and/or on the cutting element (818) is determined by the mechanical properties of the spring (813) in combination with a locator (not shown) rather than by the pressure applied by the robotic arm (814).

Associated with the robotic arm (814) and/or the robot (812) is a vibration damper (816) which is adapted to provide some damping of vibration in one or more directions. As shown in FIG. 8, the vibration damper (816) may be functionally and/or operably connected or associated with the gripper (804) as by bearings (824, 826) and may include springs, hydraulics or other capability shown to dampen vibration in the Y direction (and/or possibly in the Z direction) especially during grinding or cutting of the blade (802).

A blade profiling device (860) including a sampler (862) is used to sample blade (802) parameters so as to determine the amount and position of flash material to be removed from blade (802). The blade (802) parameters are input to controller (850) which in response to the inputs (870) sends control signals (871) to the locator, the motor, and the robot (812) devices. The control signals (871) may include signaling related to operation and positioning of these and other interconnected devices such as, for example, accurate positioning of the spacer by the operation of the motivator in the locator, the rotation of the blade (802) around axis six (810) by the operation of the robot (812), and the high-speed revolving of the edge cutter (818) by the operation of the motor.

FIG. 9 schematically illustrates edge shapes (such as LE and/or TE) A through J. For example, edge shape A includes three flats; edge shape B includes two flats connected to each other by a sharp angle; edge shape C includes two concave surfaces; edge shape D includes one flat and one concave surface; edge shape E includes two flats directed towards the center of the blade; edge shapes F through H arc includes arcs of different dimensions (for example, A and B); edge shape I includes one flat and edge shape J includes one concave surface. Other edge shapes, such as any combination of concave, convex and/or flats, may be applied.

Of course any method or process which is described herein and may be applied on a blade to form a leading edge to match predefined geometric requirements of the blade, may also be applied on the trailing edge.

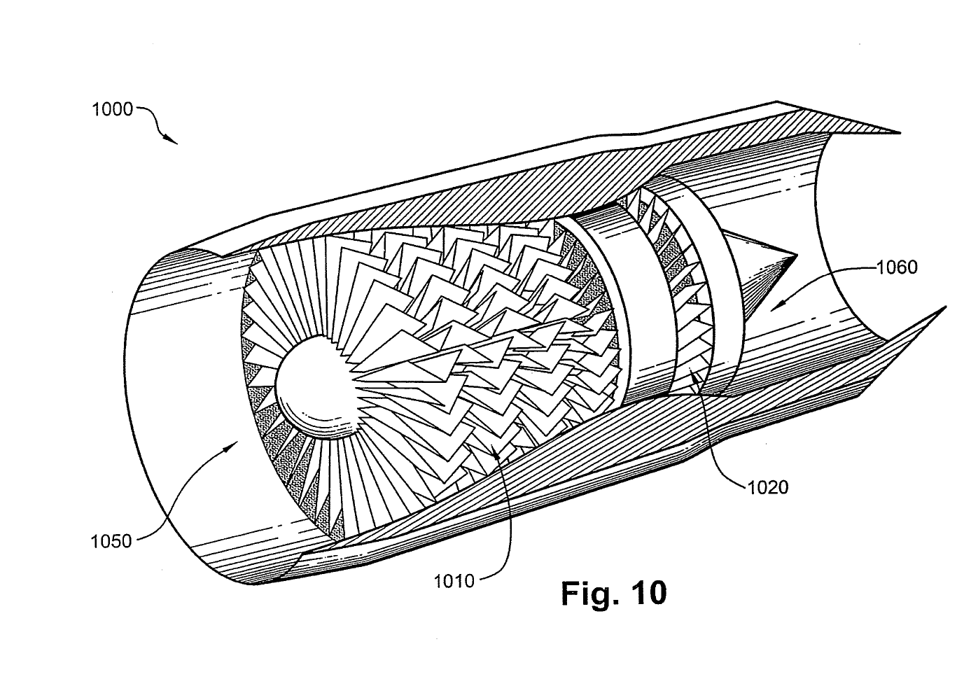

FIG. 10 schematically illustrates a jet engine (1000). The jet engine (1000) includes a plurality of rotors (1010) adapted to operate as the compressor (1050) in the jet engine (1000) and a rotor (1020) adapted to operate as the turbine (1060) in the jet engine (1000). In other embodiments of the present disclosure the rotor (1010) and rotor (1020) may be adapted to be used in other applications such as, for example, space, air, marine and/or land vehicular applications, as well as for power generation.

In addition to the exemplary aspects and embodiments described above, further aspects and embodiments will become apparent by reference to the figures and by study of the following detailed descriptions.

What we claim is:

1. A method for producing a blade comprising:
adjusting a spacer functionally associated with an edge cutter based on a sampling of the blade.

2. The method of claim 1, wherein sampling of the blade comprises determining the geometry of the blade.

3. The method of claim 1, further comprising contacting an edge segment of the blade with the edge cutter, wherein the spacer regulates the contact between the blade and the edge cutter.

4. The method of claim 1, further comprising modulating the spacer as the blade and the edge cutter are moved relative to one another in accordance with the sampling of the blade.

5. The method of claim 1, further comprising buffing the edge.

6. The method of claim 3, wherein the edge is a leading edge, a trailing edge or both.

7. An apparatus for producing a blade comprising:
a blade profiling device adapted to produce a sampling of the blade;
a spacer functionally associated with an edge cutter; and
a controller adapted to adjust a position of said spacer based on the sampling of the blade.

8. The apparatus of claim 7, wherein the edge is a leading edge, a trailing edge or both.

9. The apparatus of claim 7, wherein the controller is further adapted to cause contact between an edge segment of the blade and the edge cutter.

10. The apparatus of claim 7, wherein the controller is adapted to modulate the spacer as the blade and the edge cutter are moved relative to one another in accordance with the sampling of the blade.

11. The apparatus of claim 10, wherein the spacer is adapted to be modulated using an actuator.

12. The apparatus of claim 11, wherein the actuator is a servo motor actuator.

13. The apparatus of claim 7, further comprising a vibration damper functionally associated to a blade holder, wherein said vibration damper is adapted to ameliorate vibrational movements in one or more degrees of freedom.

14. The apparatus of claim 7, wherein the blade holder is functionally associated to a robotic arm.

15. The apparatus of claim 7, further comprising one or more buffing wheel.

16. The apparatus of claim 15, comprising two buffing wheels adapted to rotate in opposite directions.

17. A blade having a complex surface along a substantial portion of its length, said blade comprising:
a complex surface edge within a tolerance repeatability of less than 0.01 mm along a substantial portion of the length of the complex surface.

18. The blade of claim 17, wherein said substantial portion of the length of the complex surface is at least 10%.

19. The blade of claim 17, wherein the edge is a leading edge, a trailing edge or both.

20. A rotor comprising:
a set of blades having a complex surface along a portion of their respective lengths, wherein each of a subset of blades has a complex surface edge and wherein the complex surface edge is within a tolerance of less than 0.01 mm along a substantial portion of the length of the complex surface.

21. A blade cutting apparatus comprising:
a blade holder configured to retain a blade at spaced apart locations;
a blade profiling device adapted to produce a sampling of the blade;
an edge cutter configured to cut an edge of the blade, the edge cutter being driven by a motor;
a spacer configured to regulate contact between the blade and the edge cutter; and
a controller adapted to adjust a position of said spacer based on the sampling of the blade.

22. The apparatus of claim 21, wherein the controller is further adapted to cause contact between an edge segment of the blade and the edge cutter.

23. The apparatus of claim 21, wherein the controller is adapted to modulate the spacer as the blade and the edge cutter are moved relative to one another in accordance with the sampling of the blade.

24. The apparatus of claim 23, wherein the spacer is adapted to be modulated by an actuator.

25. The apparatus of claim 24, wherein the actuator is a servo motor actuator.

26. The apparatus of claim 21, further comprising a vibration damper functionally associated to a blade holder, wherein said vibration damper is adapted to ameliorate vibrational movements in one or more degrees of freedom.

27. The apparatus of claim 21, further comprising a robotic arm on which the blade holder is mounted.

28. A method for producing a blade comprising:
gripping a blade;
providing an edge cutter configured to cut an edge of the blade, the edge cutter being motor-driven;
sampling a surface of the blade;
providing a spacer configured to regulate contact between the blade and the edge cutter; and
providing a controller adapted to adjust a position of said spacer based on the sampling of the blade; and
adjusting the spacer based on a sampling of the blade.

29. The method of claim 28, wherein sampling of the blade comprises determining the geometry of the blade.

30. The method of claim 28, further comprising contacting an edge segment of the blade with the edge cutter, wherein the spacer regulates the contact between the blade and the edge cutter.

31. The method of claim 28, further comprising modulating the spacer as the blade and the edge cutter are moved relative to one another in accordance with the sampling of the blade.

32. The method of claim 28, further comprising buffing the edge.
